(19) United States
(12) Patent Application Publication
(10) Pub. No.: US 2012/0318142 A1
(43) Pub. Date: Dec. 20, 2012

(54) METHOD AND SYSTEM FOR INCREASING THE EFFICIENCY AND ENVIRONMENTAL COMPATIBILITY OF COMBUSTION PROCESSES

(75) Inventors: Jennifer Packard WEBER, Laguna Beach, CA (US); Jeffrey Goodman PACKARD, Laguna Beach, CA (US)

(73) Assignee: ALODYNE, LLC, Irvine, CA (US)

(21) Appl. No.: 13/159,753

(22) Filed: Jun. 14, 2011

(51) Int. Cl. B01D 53/14

(52) U.S. Cl. 95/189; 95/188; 96/234; 96/242

(57) ABSTRACT

A method and system for increasing the efficiency and environmental compatibility of combustion systems, preferably for heat recovery from a wet flue gas and/or for flue gas purification, especially of flue gas from the combustion of high water-content fuels, such as biomass, especially wood, and for reducing the volumetric flow of the flue gas and/or for recovery of water from the flue gas, wherein the flue gas is brought into contact with a measured quantity of concentrated hygroscopic in at least one absorber unit and the measured quantity of hygroscopic material is diluted and heated with absorption of water from the flue gas. Heated is extracted from the heated and diluted hygroscopic material after which it is concentrated in at least one separating unit by separation of water and the resulting measured quantity of concentrated hygroscopic material obtained is routed at least partially to the absorber unit.

### BACKGROUND OF THE INVENTION

1. Field of the Invention

The invention relates to a method and system for increasing the efficiency and environmental compatibility of combustion processes. Preferably, the invention relates to a method and a system for heat recovery from a wet flue gas and/or for flue gas purification, especially of flue gas from the combustion of highly water-containing fuels, such as biomass, furthermore especially from the combustion of wood, for example, in a block-type thermal power station with a thermal output of preferably less than 5 MW, especially preferably less than 1 MW, and/or for reducing the volumetric flow of the flue gas and/or for recovery of water from the flue gas.

2. Description of Related Art

The allowable values for pollutant emissions of heating installations and furnaces or combustion facilities have been made stricter in recent years by legislators in order to, in this way, contribute to reducing the environmental burden. In the combustion of wood in a wood furnace, for example polluting fine dusts are released. This also applies to the combustion of other renewable fuels. The problem of emission of fine dusts is becoming increasingly important since in recent years there has been an intensified switch from oil and coal furnaces to wood furnaces.

In addition to reducing the emission of fine dusts, the maximum possible use of the heat energy which is contained in the flue gas is desirable. In the heating installations and furnaces which are known from the prior art, the flue gas is generally released to the environment at a relatively high temperature level. This leads to heat losses.

The high volumetric flow of the flue gas requires a correspondingly large type of construction of the flue gas-carrying parts of a heating installation and furnace; this leads to correspondingly high hardware costs.

Water vapor which is contained in the flue gas when cooled leads to formation of largely visible vapor damps which are perceived as disturbing by viewers of the installations.

Wet flue gas purification is a means which has been known for decades for separating the pollutants which form in the combustion of especially fossil fuels, such as anthracite and brown coal, from the flue gas and for converting them into marketable products. For desulfurization, scrubbing with a limestone-containing or hydrated lime-containing suspension has proven advantageous and has displaced other wet, dry, or half-dry methods. This wet desulfurization calls for the acid gases present in the flue gas to be dissolved in a first reaction step in the scrubbing solution and to be partially dissociated. The oxygen still present in the flue gas or that introduced in addition oxidizes the sulfite ions in a second reaction step into sulfate ions which are reacted in a third reaction step with limestone or hydrated lime to calcium sulfate which ultimately precipitates as gypsum and is separated. The cleaned, cooled flue gases are reheated after desulfurization and leave the smokestack via droplet separators with a minimum temperature of 75° C. Together with the sulfur compounds, particles which are contained in the flue gas are separated in flue gas scrubbing and thus the fine particle content in the flue gas is reduced.

The intended cooling of the flue gas with subsequent heating before emergence from the smokestack is disadvantageous in methods for wet desulfurization of flue gasses; this leads to energy losses and reduces the total efficiency of the installation. In wet desulfurization, a large part of the scrubbing water is vaporized and absorbed by the flue gas so that both material and also energy disadvantages arise. The high proportion of latent heat of the flue gas cannot be used or can only be inadequately used and is further increased by additional water absorption.

In flue gases with low sulfur concentrations, such as flue gases from the combustion of biomass, such as wood, it is fundamentally also possible to cool the flue gas to below the dew point, particles being separated from the flue gas with the condensate which has formed. The condensation of the water vapor which is contained in the flue gases begins only at flue gas temperatures of roughly 65° C., at temperatures of 50° C. generally roughly half the flue gas water vapor being condensed. For various reasons, the use of the condensation enthalpy in this low temperature range is only possible in an economically feasible manner in the exceptional case. In order to be able to preclude further condensation of the water vapor which has remained in the flue gases in any case in the smokestack, subsequent heating of the flue gases to 70° C. and more is necessary; this necessitates making heat energy available and is, in turn, associated with heat losses.

### SUMMARY OF THE INVENTION

One object of this invention is to make available a method and a system of the initially named type which allows better utilization of the heat energy contained in the hot flue gas.

Another object of this invention is to make available a method and a system of the initially named type which enable flue gas purification, especially the separation of (fine) particles from the flue gas, easily and at low cost.

Another object of this invention is to recover energy from highly water-containing flue gas at low costs and with little process engineering effort and thus to achieve high overall energy efficiency of combustion installations or a heating plant and furnace. In this case, flue gas purification can be a secondary objective of the invention, specifically the separation of particles from the flue gas as a side effect of energy recovery. Here, the method in accordance with the invention and the device in accordance with the invention will be characterized by simple process engineering and process management and low hardware and operating costs.

Moreover, one object of the invention is to make available a method and a device of the type under consideration, with which the volumetric flow of the flue gas and especially the formation of vapor damps in the release of the flue gas into the environment are reduced.

Finally, it is an object of this invention to make available a method and a device of the type under consideration which allow water recovery from the flue gas, easily and at low cost.

The aforementioned and other objects of the invention are achieved by a method and by a system with the features described herein.

It is provided in accordance with the invention that the flue gas be brought into contact with a measured quantity of a concentrated hygroscopic material in at least one absorber unit and the measured quantity of hygroscopic material is diluted and heated with absorption of water from the flue gas, the diluted less hygroscopic material being concentrated by separation of water in at least one separating unit which is connected downstream of the absorber unit and the measured quantity of hygroscopic material which is been obtained in this way being routed at least partially to the absorber unit. Moreover, the useful heat from the measured quantity is tapped between the absorber unit and the separating unit. The system in accordance with the invention is made especially for carrying out the method in accordance with the invention and has at least one absorber unit and at least one separating unit which is connected downstream of the absorber unit, the absorber unit and the separating unit being connected by a measured quantity circuit which routes the measured quantity of hygroscopic material.

In the absorber, the flue gas is brought into contact in an open absorption process with the measured quantity of hygroscopic material and a hygroscopic absorbent. As a result of the partial pressure differences, the water vapor which is contained in the wet flue gas is removed from the flue gas. As long as the water vapor in the flue gas has a higher partial pressure than the measured quantity of hygroscopic material, the partial pressure is equalized so that that water vapor from the flue gas is condensed and released in liquid form to the measured quantity and the flue gas is thus dehydrated. At the same time, the measured quantity is diluted by the absorbed water. The sorptive dehydration works at most until an equilibrium state is achieved between the partial pressure of the water vapor in the flue gas and the saturation vapor pressure over the measured quantity of hygroscopic material.

The method in accordance with the invention makes it possible to easily and economically dehydrate the flue gas even at temperatures above the dew point of the water vapor, and the condensation and convection heat at higher temperatures can be advantageously used. At the same time condensation of water vapor causes intensive precipitation of (fine) particles from the flue gas and the reduction of the volumetric flow of the flue gas with lower possible vapor damp formation when the flue gas leaves the smokestack. Due to the sorptive dehydration of the flue gas, the smokestack remains dry so that the wear on the smokestack decreases. The useful heat which has been tapped from the measured quantity of hygroscopic material can be, for example, fed into a heating network. The condensation water which is formed in flue gas dehydration can be used as process water after separation from the measured quantity in the heating installation and furnace or combustion facility; this leads to the saving of drinking water and a further reduction of operating costs.

The establishment of equilibrium between the partial pressure of the water vapor in the flue gas and saturation vapor pressure over the measured quantity of hygroscopic material is largely influenced and fixed by the reaction temperature and the reaction pressure of sorptive dehydration. The temperature and the moisture content of the flue gas at the outlet from the absorber unit are also determined by the phase equilibrium and can be set via the composition of the measured quantity of hygroscopic material.

The transfer of heat and mass in absorption can take place via suitable exchange surfaces of packings which are located in the absorber unit. In this case, the concentrated hygroscopic measured quantity can flow distributed by means of suitable spray devices over the exchange surfaces in countercurrent to the flue gas in the direction of gravity. The packing can be made, for example, of fillings, such as Raschig rings, Pall rings, Intalox saddles or Berl saddles.

The tapping of useful heat from the measured quantity can take place at various locations and is dependent on the type and execution of the separating unit and the separating process which is intended for separation of water from the diluted measured quantity. This will be explained in detail below.

In the dehydration of air, the measured quantity of hygroscopic material is increasingly diluted by the absorption of water vapor. In order to regenerate the diluted measured quantity, i.e., to concentrate it and thus to re-produce the hygroscopic properties, it can be provided that the water content of the measured quantity in a desorber unit which is connected downstream of the absorber unit be reduced by at least partial vaporization of the water portion. For this purpose, the diluted measured quantity in the desorber unit can be heated to a temperature at which the water vapor pressure of the measured quantity exceeds the atmospheric pressure or the ambient pressure; this results in vaporization of the water. The tapping of useful heat from the heated concentrated measured quantity after its emergence from the separating unit and/or from the separated water is possible and advantageous.

Making available the heat energy which is necessary for desorption is associated with a higher process engineering effort. If no exhaust heat is available at a high enough temperature level, heat energy must be produced by combustion of fuel; this is associated with additional operating costs and heat losses. The concentrated hygroscopic measured quantities which are suitable for absorption purposes, moreover, have a high boiling point so that a large amount of energy is necessary to vaporize the water portion. Depending on the type and composition of the measured quantity, multistage vaporization can be necessary for regeneration of the measured quantity; this is expensive.

For this reason, it is preferably provided in accordance with the invention that water in the liquid state be separated by a membrane separation method, especially by reverse osmosis, from the diluted measured quantity. According to the device, the system in accordance with the invention correspondingly has a membrane separation means which works especially according to the principle of reverse osmosis. Reverse osmosis is a physical method for concentration of substances which are dissolved in liquids and in which with pressure the natural osmosis process is reversed. In this case, the diluted measured quantity is supplied under high pressure to the membrane separation means and liquid water is separated from the measured quantity by a semi-permeable membrane. The pressure for reverse osmosis can be, for example, between 60 to 80 bar since the measured quantity has a much higher osmotic pressure than, for example, drinking water. Fundamentally, higher pressures can also be used.

The membrane separation enables simple and economical regeneration of the diluted measured quantity. It is not necessary to make available heat energy additionally for regeneration of the measured quantity. Regeneration by membrane separation is therefore especially advantageous when exhaust heat at a relatively high temperature is not available and heat energy for regeneration of the measured quantity would have to be produced by combustion of a fuel. Otherwise, in membrane separation water in liquid form is separated which can be used as process water and can make the incorporation of additional drinking water into the process dispensable. The hardware cost compared to regeneration of the measured quantity due to evaporation also drops since, in membrane separator, a condenser to separate the water in liquid form is unnecessary.

If a membrane separation method is used for regeneration of the measured quantity, tapping of heat from the diluted, heated measured quantity can take place after its emergence from the absorber unit and before separation of water in the membrane separation means. Thus, tapping of heat at a higher temperature level is possible and moreover, it is ensured that the temperature of the measured quantity does not exceed a maximum operating temperature of the respective membrane separation method. The average temperature of heat tapping can be between 80 to 120° C., preferably roughly 100° C. The tapped heat can be fed into a heating circuit.

In the regeneration of the measured quantity, especially by reverse osmosis, but also when the regeneration of the measured quantity takes place by heating above the boiling point of water, the heat content of the separated water which can be present liquid (reverse osmosis) or gaseous (vaporization) depending on the separation process can be used.

If the diluted measured quantity is regenerated or concentrated by membrane separation, at least one filter can be connected upstream of the membrane separation means to prevent mechanical or chemical damage to the membrane. With a fine filter, especially particles which have passed in the absorber unit together with the condensed water out of the flue gas into the measured quantity can be separated from the measured quantity.

If water is separated from the diluted measured quantity by a membrane separation process, as a result of the high operating pressure of membrane separation, it is advantageous to transfer the pressure energy from the concentrated measured quantity (after emerging from membrane separating unit) and the diluted measured quantity (preferably after heat tapping and before compression to the operating pressure of membrane separation). To do this, a pressure exchanger can be used, whose use is already known especially in sea water desalination plants. The task of the pressure exchanger is to recover a part of the pressure energy which is contained by the concentrated measured quantity which emerges from the membrane separation means and to supply it to the diluted measured quantity in order to reduce the energy demand of the plant. This pressure exchanger is described for example in EP 2 078 867 A1 and corresponding U.S. Patent Application Publication 2011/0008182.

The system in accordance with the invention, accordingly, has at least one pressure exchanger which connects an inflow line from the absorber unit to the membrane separation means and a drain line from the membrane separation means to the absorber unit for pressure exchange.

In order to limit the entry temperature of the flue gas into the absorber unit, there can be cooling of the flue gas before entering the absorber unit. The tapping of heat takes place here at a comparatively higher temperature level; this is advantageous.

In conjunction with the invention, it has been shown that sorptive dehydration of the flue gas with a high degree of dehydration and with high economic efficiency of the process is achieved when the flue gas is supplied to the absorber unit with an entry temperature between 80 and 200° C., preferably between 100 and 150° C., furthermore preferably roughly 120 to 130° C. The flue gas can be removed from the absorber unit with an exit temperature of greater than 50 to 120° C., preferably of greater than 60 to 100° C., furthermore preferably of greater than 70 to 80° C. The concentrated hygroscopic measured quantity which is routed preferably in countercurrent to the flue gas can be supplied to the absorber unit with an entry temperature between 60 and 130° C., preferably less than 80° C., furthermore preferably roughly 70 to 75° C. The exit temperature of the diluted, heated measured quantity can be between 100 and 180° C., preferably between 120 and 170° C., furthermore preferably roughly 140 to 150° C.

Moreover, the moisture content of the flue gas can be in the region between 0.1 and 0.2 kg_{water}/kg_{flue gas}, preferably between 0.12 and 0.16 kg_{water}/kg_{flue gas, dry}, especially roughly 0.14 kg_{water}/kg_{flue gas, dry}. After dehydration then the moisture content of the flue gas is less than 0.07 kg_{water}/kg_{flue gas, dry}, preferably less than 0.05 kg_{water}/kg_{flue gas dry}, especially roughly 0.03 kg_{water}/kg_{flue gas dry} or less. It goes without saying that all intermediate values of the aforementioned ranges can be regarded as disclosed and belonging to the invention, even if this is not described in particular.

The measured quantity can be a hygroscopic solution or dispersion, especially an acid or base solution or dispersion. Preferably a hygroscopic, especially saturated aqueous solution or dispersion of salts of alkaline or alkaline earth metals, especially preferably bromides and/or nitrates, is used as the measured quantity. By using open absorption circulation processes with preferably aqueous solutions of acids and salts, use of the condensation enthalpy of the water contained in the flue gas is easily and economically possible at a higher temperature level. By dehydrating the flue gas using a hygroscopic measured quantity, at the same temperatures noticeably higher degrees of dehydration can be achieved than with simple condensation by cooling of the flue gas. The measured quantity can be an aqueous, highly concentrated solution of easily soluble salts, such as acetates, carbonates, chlorides or their mixtures.

The aforementioned aspects and features of this invention as well as the aspects and features of this invention which are described below with reference to the accompanying drawing can be implemented independently of one another, in any combination, even if it is not described in particular. Here, any described feature or aspect can acquire inherently inventive importance. Other advantages, features, properties and aspects of this invention will become apparent from the following description of a preferred embodiment with reference to the accompanying drawing.

### BRIEF DESCRIPTION OF THE DRAWING

The sole FIGURE is a schematic diagram of a system for increasing the efficiency and environmental compatibility of a combustion process.

### DETAILED DESCRIPTION OF THE INVENTION

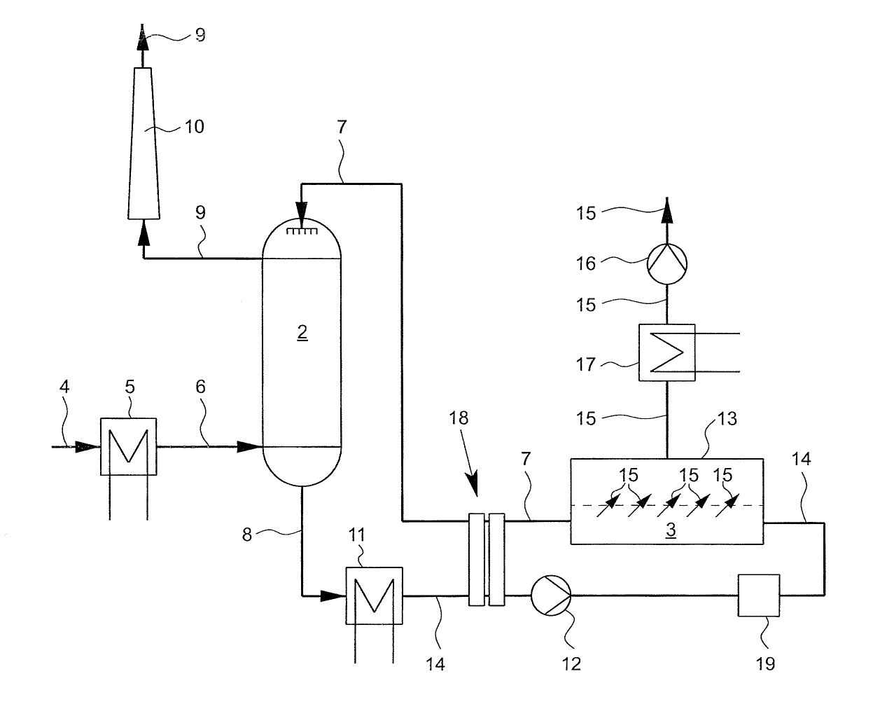

Using the system 1 shown in FIG. 1, by absorptive flue gas dehydration the water vapor which is contained in the flue gas 6 and which necessarily forms in the combustion of fossil fuels, such as for example heating oil and natural gas, or of biogenic fuels such as for example biogas or wood, is removed at least partially from the flue gas 6 and supplied to another use. With the water, fine particles are effectively separated from the flue gas 6. Use of the condensation enthalpy at temperatures above the dew point of the flue gas water vapor is possible. Vapor damp formation upon emergence of a dehydrated flue gas 9 in the release into the environment is reduced or precluded.

Using FIG. 1, the dehydration of flue gas 6 from stoichiometric combustion of methane is explained by way of example. The described process is, however, suitable especially for treatment of flue gases from combustion of highly water-containing fuels, such as biomass, furthermore especially from the combustion of wood, for example, in block-type thermal power stations with a thermal output of preferably less than 5 MW, especially preferably of less than 1 MW.

The illustrated system has an absorber unit 2 and a separating unit 3 which is connected downstream of the absorber unit 2. The absorber unit 2 and the separating unit 3 are connected to one another via a measured quantity circuit which routes the gas through measured quantity of at least one hygroscopic material.

Hot, wet flue gas 4 is cooled in a heat exchanger 5 to a temperature of roughly 120° C. The cooled, wet flue gas 6 has a water content of roughly 0.14 kg/kg_{flue gas, dry}. This cooled wet flue gas 6 is routed into the absorber unit 2 which is filled with a material to improve heat and mass transport. In countercurrent, the flue gas 6 is brought into contact with a concentrated hygroscopic solution, for example, an aqueous solution of the salts lithium bromide or calcium nitrate, in the absorber unit 2. The hygroscopic solution is injected directly into the flue gas flow as a measured quantity of concentrated hygroscopic material 7 with a temperature of roughly 70° C. in an open absorption process; this leads to dehydration of the flue gas 6. Due to the partial pressure differences, the water vapor contained in the flue gas 6 is condensed out, as a result of which the concentrated hygroscopic measured quantity 7 is diluted and at the same time heated. On the bottom of the absorber unit 2 a diluted, heated measured quantity 8 is removed. The cooled and dehydrated flue gas 9 leaves the absorber unit 2 with a temperature of roughly 70° C. and a relative moisture content of less than 15%, the absolute moisture content is roughly 0.03 kg_{water}/kg_{flue gas, dry}.

Thus, during the absorption process in the absorber unit 2 roughly 0.11 kg_{water}/kg_{flue gas, dry} has been condensed out and a condensation enthalpy of 360 KJ/kg_{flue gas, dry} has been supplied to the measured quantity 7. This energy supply leads to an increase of the temperature of the measured quantity 7 so that the diluted, heated measured quantity 8 at the outlet from the absorber unit has a temperature of roughly 150° C. The cooled, dry flue gas 9 is discharged to the environment via a smokestack 10.

After emerging from the absorber unit 2, the diluted, heated measured quantity 8 is cooled for tapping of the heat energy in a heat exchanger 11. The average temperature of the thermal tapping in the heat exchanger 11 is roughly 100° C.

A diluted, cooled measured quantity 14 emerges from the heat exchanger 11 and is brought by means of a pump 12 to the operating pressure of a membrane separation means 13 which works according to the principle of reverse osmosis as part of the separating unit 3. In the membrane separation means 13, water 15 in liquid form is separated from the diluted measured quantity 14, and in this way, the measured quantity of hygroscopic material 14 is concentrated. A concentrated measured quantity of hygroscopic material 7 emerges from the membrane separation means 13 and is routed to the absorber unit 2 so that a closed measured quantity circuit is formed.

The separated water 15 is delivered with a pump 16 via a heat exchanger 17 in which it is cooled with recovery of the useful heat. The water 15 can then be supplied to another use.

An inflow line to the membrane separation means 13 for the diluted measured quantity 14 and a drain line for the concentrated hygroscopic measured quantity 7 to the absorber unit 2 can be connected to one another for pressure exchange via at least one pressure exchanger unit 18. The pressure exchanger unit 18 is used for transfer of pressure energy from the concentrated hygroscopic measured quantity 7 after emerging from the membrane separation means 13 and the diluted measured quantity 14 before entering the pump 12. Thus, the energy demand for pumping the diluted measured quantity 14 to the operating pressure of the membrane separator is reduced and high economic efficiency of the method is ensured. Between the pressure exchanger unit 18 and the membrane separation means 13 there is a filter 19 which is made especially as a fine filter and is designed, for solid particle separation, and thus, for protecting the membrane separation means 13.

It is not shown that, otherwise, upstream of the membrane separation means 13, there can be a filter unit to separate especially particles from the diluted measured quantity 14 and to preclude damage or blockage of the membrane by the components which have been separated from the flue gas 6.

What is claimed is:

1. Method for increasing the efficiency and environmental compatibility of combustion systems, for at least one of heat recovery from a wet flue gas produced by the combustion of high water content fuels in a block-type thermal power station with a thermal output less than 5 MW, reduction of volumetric flow of the flue gas and recovery of water from the flue gas, comprising the steps of:
bringing the flue gas into contact with a measured quantity of concentrated hygroscopic material in at least one absorber unit,
diluting the measured quantity of concentrated hygroscopic material in said at least one absorber unit with water vapor adsorbed from the flue gas and thereby producing heating of the hygroscopic material at the same time,
withdrawing dried flue gas from a first area of said at least one absorber unit,
withdrawing heated and diluted hygroscopic material from a second area of said at least one absorber unit and directing it to at least one separating unit,
tapping of useful heat from the heated and diluted hygroscopic material,
concentrating the diluted hygroscopic material in said at least one separating unit by separation of water from the hygroscopic material to obtain said measured quantity of concentrated hygroscopic material, and
at least partially routing the concentrated hygroscopic material from the at least one separating unit to the at least one absorber unit.

2. Method in accordance with claim 1, wherein the separation of water is performed by a membrane separation method.

3. Method in accordance with claim 2, wherein the membrane separation method is a reverse osmosis method.

4. Method in accordance with claim 1, wherein said tapping of useful heat takes place before separation of water from the diluted hygroscopic material.

5. Method in accordance with claim 1, comprising the further step of tapping heat from the water separated from diluted hygroscopic material.

6. Method in accordance with claim 2, wherein solid particles are separated from the diluted measured quantity before membrane separation.

7. Method in accordance with claim 2, comprising the further step of transferring pressure between the concentrated measured quantity from the at least one separating unit and the diluted hygroscopic material directed from the at least one absorber unit to the at least one separating unit.

8. Method in accordance with claim 1, wherein heat is tapped from the flue gas before entry into the at least one absorber unit.

9. Method in accordance with claim 1, wherein the flue gas is supplied to the at least one absorber unit with an entry temperature between 80 and 200° C.

10. Method in accordance with claim 1, wherein the flue gas is removed from the at least one absorber unit with an exit temperature of greater than 50 to 120° C.

11. Method in accordance with claim 1, wherein the concentrated hygroscopic measured quantity is supplied to the at least one absorber unit in a countercurrent flow relative to the flue gas with an entry temperature between 60 and 130° C.

12. Method in accordance with claim 1, wherein the heated diluted measured quantity of hygroscopic material is removed from the at least one absorber unit with an exit temperature between 100 and 180° C.

13. Method in accordance with claim 1, wherein the flue gas supplied to the at least one absorber unit has a with a moisture content between 0.1 and 0.2 kg_{water}/kg_{flue gas, dry}.

14. Method in accordance with claim 1, wherein flue gas removed from the at least one absorber unit has a moisture content of less than 0.07 kg_{water}/kg_{flue gas, dry}.

15. Method in accordance with claim 1, wherein the measured quantity of hygroscopic material is a hygroscopic solution or dispersion.

16. Method in accordance with claim 15, wherein the hygroscopic solution or dispersion is a saturated aqueous solution or dispersion of salts of alkaline or alkaline earth metals.

17. System for increasing the efficiency and environmental compatibility of combustion processes, for at least one of heat recovery from a wet flue gas produced by the combustion of high water content fuels in a block-type thermal power station with a thermal output less than 5 MW, reduction of volumetric flow of the flue gas and recovery of water from the flue gas, comprising:
at least one absorber unit connected to a source wet flue gas and having an outlet for dried flue gas in a first area thereof and an outlet for heated hygroscopic material diluted with water vapor adsorbed from the flue gas, and in which wet flue gas is contacted with concentrated hygroscopic material,
at least one separating unit which is connected downstream of the absorber unit, and
a measured quantity circuit through which diluted hygroscopic material is routed to the at least one separating unit from the at least one absorber unit and through which concentrated hygroscopic material is directed from the at least one separating unit to the at least one absorber unit.

18. System in accordance with claim 17, wherein the at least one separation unit has a reverse osmosis membrane separation means.

19. System in accordance with claim 18, wherein at least one of at least one heat exchanger for tapping of useful heat from the heated and diluted hygroscopic material and at least one filter unit are provided in an inflow line of the measured quantity circuit from the at least one absorber unit to the at least one separation means.

20. System in accordance with claim 18, wherein an inflow line of the measured quantity circuit from the at least one absorber unit to the at least one separation means and a drain line of the measured quantity circuit from the at least one separation means to the at least one absorber unit are connected to one another via at least one pressure exchanger unit for pressure exchange.
